(19) United States
(12) Patent Application Publication
(10) Pub. No.: US 2008/0130503 A1
(43) Pub. Date: Jun. 5, 2008

(54) METHOD AND SYSTEM FOR FORWARDING ETHERNET FRAMES OVER REDUNDANT NETWORKS WITH ALL LINKS ENABLED

(76) Inventor: Gideon Kaempfer, Raanana (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 11/947,863

(22) Filed: Nov. 30, 2007

Related U.S. Application Data
(60) Provisional application No. 60/868,098, filed on Dec. 1, 2006.

(51) Int. Cl. G08C 15/00

(52) U.S. Cl. 370/235

(57) ABSTRACT

Disclosed herein are methods and systems for forwarding Ethernet frames over a redundant network with its links enabled utilizing shortest paths between nodes. Network nodes suppress traffic from traveling in loops by identifying and dropping recurring frames within a given (typically short) timeframe based on a set of increasingly significant tests enabling the identification of such frames using very low memory resources. In addition, correct node location learning is enabled by ignoring or dropping frames that contradict prior learning within a given (typically short) timeframe. This is achieved by identifying frames arriving from a single source on more than one ingress interface within a given (typically short) timeframe. Within this timeframe, only the frames arriving from such a source on the first interface the source is identified on are used for node location learning. This interface is hence treated as the only interface the source has been identified on for the purpose of the packet forwarding algorithm.

### CROSS-REFERENCE TO RELATED APPLICATIONS

This application is a non-provisional application filed pursuant to 35 U.S.C. 1.53(b) and claims the benefit of the filing date of the United States provisional application for patent that was filed on Dec. 1, 2006, assigned Ser. No. 60/868,098 and bearing the title of “A Method and System for Forwarding Ethernet Frames over Redundant Networks with All Links Enabled”, which application is hereby incorporated by reference.

### FIELD OF THE INVENTION

The present disclosure relates to redundant network configurations, and in particular, methods and systems for enabling switching systems to cope with frames looping in the network.

### BACKGROUND

Packet-switched networks have become common for transferring many types of data among network nodes. In a packet-switched network, nodes share a communications channel via a virtual circuit, or non-dedicated connection through a shared medium that gives the high-level user the appearance of a dedicated, direct connection from the source node to the destination node. Messages sent over such a network are partitioned into packets, which may contain an amount of data, accompanied by addressing information. Packets are sent from a source node to a destination node one packet at a time as the network hardware delivers the packets through the virtual circuit. Internet Protocol networks operate in this manner, as do Ethernet networks.

In packet-switched networks and in Ethernet networks in particular, there is a need for redundancy in pathways between source and destination nodes. If there is only one path between a source and destination, and there is a failure of any intermediate node or communication line, then messages cannot be delivered. Multiple active paths between nodes, however, can cause loops in the network. Loops can result in nodes seeing the same packet over and over, thereby degrading network performance.

Nodes in Ethernet networks learn the relative location of other nodes in the network based on the observation of the port on which packets from these nodes arrive. If packets arrive from the same node via multiple ports, as may occur as a result of loops in the network, the packet forwarding algorithms, especially in an Ethernet network, can become confused. Hence, for an Ethernet network to function properly, it is typically configured so that only one active path can exist between two nodes.

One system developed to address these concerns is the Spanning Tree Protocol (STP) as defined by IEEE standards such as 802.1d, 802.1w (Rapid Spanning Tree Protocol—RSTP) and 802.1s (Multiple Spanning Tree Protocol—MSTP). STP is a link management protocol that provides path redundancy while preventing undesirable loops in the network. To provide path redundancy, STP defines a tree that spans all switches in an extended network. STP forces certain redundant data paths into a standby or blocked state. If one network segment in the STP becomes unreachable, or if STP costs change, the spanning-tree algorithm reconfigures the spanning-tree topology and reestablishes the link by activating a standby path.

While the STP provides the benefits of path redundancy and manages the problems created by path redundancy, it still leaves issues to be overcome. These issues include but are not limited to the following issues:
a. Sub-optimal latency: Since the STP forces all network traffic to travel over a tree, frequently packets travel from one node to the other over longer paths than those possible had all links been enabled for traffic forwarding. As a result, the duration of travel from one node to the other may be significantly longer than the optimal duration as would have been experienced had all links been enabled for traffic forwarding and shortest path forwarding had been enabled.
b. Sub-optimal throughput: The use of a spanning tree for forwarding may concentrate more traffic onto links that are active than would have been required had all links been enabled. Thus, the links of the spanning tree may constitute bandwidth bottlenecks in the network which could have been eliminated.
c. Sub-optimal network interruption in the event of link failures: In the event that an active link in the tree fails, data connectivity may be disrupted for a period ranging from seconds to tens of seconds until the STP reconfigures the spanning tree. During this period, nodes in the network may experience disconnects that could have been avoided in cases where the shortest path between the nodes does not experience such a failure but is not used due to links disabled by the STP.
d. Management overhead: In general, a network operated using the STP must be managed and mapped out by an individual. Even when the protocol can self-configure, often the resulting network configuration is sub-optimal, and optimization can only be achieved by an individual altering the configuration.

There is a need in the art for a method to enable shortest path forwarding over Ethernet networks while preserving their simplicity of configuration and protecting them from the ill effects that loops may have on network performance and packet forwarding algorithms.

### SUMMARY OF THE INVENTION

Disclosed herein are exemplary methods and systems for forwarding Ethernet frames over a redundant network with its links enabled utilizing shortest paths between nodes.

Network nodes suppress traffic from traveling in loops by identifying and dropping recurring frames within a given (typically short) timeframe based on a set of increasingly significant tests enabling the identification of such frames using very low memory resources.

In addition, correct node location learning is enabled by ignoring or dropping frames that contradict prior learning within a given (typically short) timeframe during which loop suppression is expected to eliminate potentially looping frames. This is achieved by identifying frames arriving from a single source on more than one ingress interface within a given (typically short) timeframe. Within this timeframe, only the frames arriving from such a source on the first interface the source was identified on are used for node location learning. This interface is hence treated as the only interface the source has been identified on for the purpose of the packet forwarding algorithm. An exemplary timeframe can be in the range of few microseconds to tens of milliseconds, for example.

In some embodiments of the present invention in the event of network topology changes such as a link failure or recovery, nodes forward topology change notifications to their neighbors to clear or reduce the lifetime of node location information learned, and to enable correct learning of updated information based on the new network topology.

Ethernet switching devices such as Ethernet switches may be implemented to use the above methods as an integral part of their functionality in data networks. An alternate embodiment of the present invention may use complementary systems that may implement methods of the present invention. Such complementary systems may be deployed in adjacency to standard Ethernet switches and control the Ethernet switches according to the dynamics of the network. Embodiments of the present invention enable the switches to perform shortest path forwarding in a redundant network where all links are enabled.

Other objects, features, and advantages of the present invention will become apparent upon reading the following detailed description of the embodiments with the accompanying drawings and appended claims.

### BRIEF DESCRIPTION OF THE DRAWINGS

Preferred embodiments of the invention will now be described, by way of example, with reference to the accompanying drawings.

FIG. 1 is a block diagram with relevant elements of an exemplary data network with a loop in it.

FIG. 2 is a block diagram with relevant elements of an exemplary data network with multiple loops in it.

FIG. 3 illustrates a flowchart with relevant steps of a procedure for identifying recurring frames.

FIG. 4 illustrates a flowchart with relevant steps of a procedure for testing a frame.

FIG. 5 illustrates a block diagram with relevant elements of an Ethernet switch with a loop enabling element.

### DETAILED DESCRIPTION

Turning now to the figures in which like numerals represent like elements throughout the several views, exemplary embodiments of the present invention are described. For convenience, only some elements of the same group may be labeled with numerals. The purpose of the drawings is to describe exemplary embodiments and not for production. Therefore features shown in the figures are chosen for convenience and clarity of presentation only.

In general, Ethernet switching devices such as Ethernet bridges as described in the art and as defined by standards such as IEEE Std 802.1D-2004, forward Ethernet frames based on destination addresses appearing on these frames. They may employ two modes of forwarding: forwarding to the destination through a single egress interface or forwarding to the destination through multiple interfaces excluding the one on which the frame has arrived, possibly limited to a subset of such interfaces as dictated by security or network partitioning directives such as VLAN definitions as described in the art by standards such as IEEE Std 802.1Q-2003.

Address learning is performed by Ethernet switching devices by recording the source address appearing on frames arriving on an ingress interface and associating such addresses with the ingress interface. Such device forwards a frame with a given destination address through a single egress interface only if this address has previously been learned by the device and it forwards it through the interface that was associated with it most recently. Otherwise, if the address is unknown, the frame is forwarded to multiple interfaces as if it were a broadcast frame. By remembering only the most recent association, Ethernet switching devices allow nodes to be relocated from time to time within the network.

In the presence of multiple paths between nodes in the network, the address of a given node may appear as the source address on frames arriving on multiple interfaces of an Ethernet switching device. This phenomenon may cause an Ethernet switching device to wrongly associate an address with an interface that may eventually cause a frame not to arrive at its destination by causing it to infinitely loop in the network or to be discarded by a switch that believes it has arrived on an interface it must exit through.

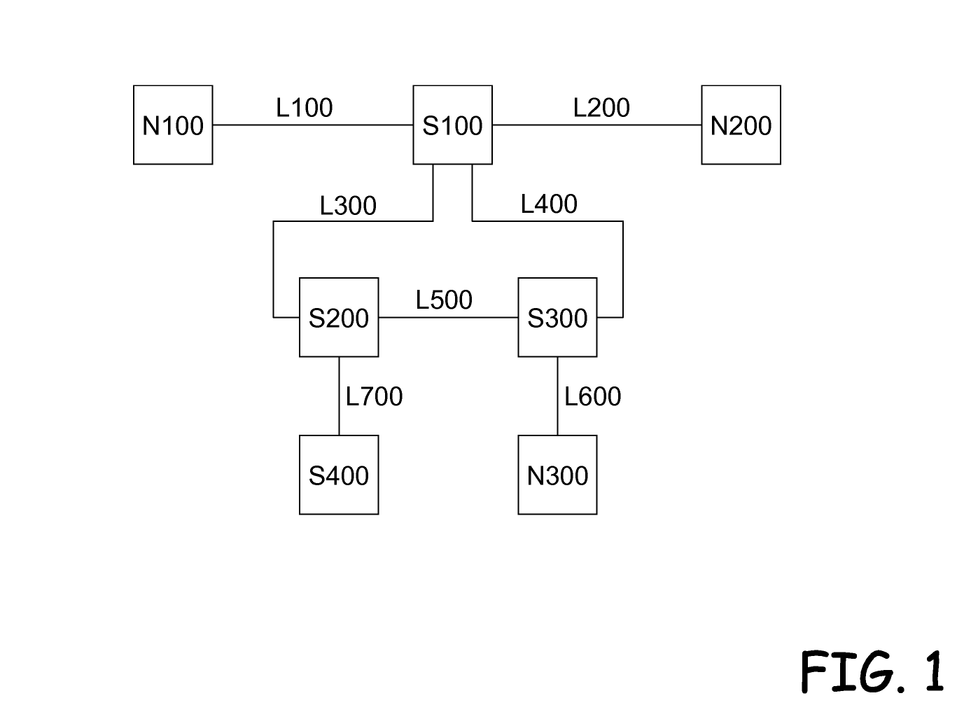

FIG. 1 is an exemplary embodiment of a network with a loop in it and the effect such a loop may have on traffic forwarding. It consists of four Ethernet switches (S100, S200, S300 and S400) and three nodes (N100, N200 and N300) sending frames destined to each other. The switches and nodes are connected to each other via a set of links (L100, L200, L300, L400, L500, L600 and L700) as depicted. Assume that initially switches have no knowledge of the nodes in the network and that no means for disabling links is in effect (i.e. no Spanning Tree Protocol is used). In addition, for the sake of simplicity, assume that L700 is disconnected (later on, its revival from this state will be considered a topology change). The following set of events may occur:
a. N100 sends a frame with destination N200 to S100.
b. S100 has no knowledge of N200 and forwards the frame to all its interfaces excluding the interface that the frame was received on. Hence, S200, S300 and N200 receive a copy of the frame. In addition it associates N100 with link L100.
c. S200 and S300 act similarly to S100 above and hence forward the frame to each other. In addition they associate N100 with L300 and L400 respectively.
d. S200 and S300 receiving the frame from each other forward it to S100. S300 also forwards the frame to N300. In addition, both switches associate N100 with L500.
e. S100 still has no knowledge of where N200 is, so it forwards the two incoming frames to N100, N200 and one copy of the frame from S200 to S300 and one copy of the frame from S300 to S200. In addition, depending on the exact arrival times of the frames from S200 and S300, it associated N100 with either L300 or L400.
f. If no further frames are sent by N100 or N200, steps (c) through (e) repeat indefinitely, effectively causing two identical frames to travel in the loop—one clockwise and one counter clockwise.

Note that under these circumstances, S100, S200 and S300 all constantly change the association of address N100 to point at one of the ports through which they are connected to an adjacent switch. Hence, in the event that node N300 would send a frame destined to N100, it would either get dropped or would infinitely loop around but would never be sent by S100 to N100 since N100 never gets associated again to L100.

### Exemplary Method for Correct Address Learning in the Presence of Multiple Paths (CALPMP)

In order to correct the learning, and hence forwarding behavior, as described in the example above and depicted in FIG. 1, the current learning algorithm of the devices needs to be modified. In an exemplary learning method, instead of associating a source address with the ingress interface immediately and unconditionally (as in the standard approach for learning that is typically defined in the art), the association can be made under the condition that the same source address was not recently (within a given time period) observed as the source address of a frame received from a different ingress interface. This time period will be termed as the “Learning Ban Period” or “LBP” hereafter. LBP can be in the range of few microseconds to tens of milliseconds or even beyond. The new learning method can be referred to as the LBP method. Note that the LBP is measured from the last arrival time of a frame with the given source address on the interface it is associated with (and not just the time at which the association was made).

The exemplary LBP method ensures that initially, and for the duration of the LBP, the switches retain the information regarding the first association of an address to an interface. In the example above associated with FIG. 1, this would ensure that S100 retains the association of N100 to L100, S200 and S300 associate N100 to L300 and L400 respectively and if the LBP is such that it lasts until N300 sends a frame to N100, S300 will forward it to L400 and S100 will forward it to L100 and it will reach N100 over the shortest possible path in the network.

During the LBP period learning is essentially disabled (i.e. re-association of the address with a new ingress interface is disabled). In a static network topology, the LBP may be set to infinity. However, in practice, nodes may be moved from time to time from one location to another and network elements may fail or recover causing paths to nodes to change.

In the example above associated with FIG. 1, if the LBP is some finite time period shorter than the time it takes until N300 sends the message to N100, and since there may be messages looping indefinitely in the loop, the initial associations of N100 may be overwritten as described in the original example. Hence, despite the LBP method disclosed above, the message from N300 will not reach N100. Therefore, in addition to the LBP mechanism, another mechanism can be added in order to eliminate looping traffic within the LBP. If all looping traffic can be eliminated within the LBP, no danger or wrong re-association of addresses to interfaces is guaranteed and hence forwarding will commence as long as the network topology is stable.

In the event of network topology changes, a situation may arise where a node (and its address) is associated to an interface through which it can no longer be reached. Therefore, a mechanism is required for erasing address associations in the event they are outdated. Such mechanisms have been proposed and standardized in the art and are commonly known as “address aging” mechanisms. If after a given period, called the “aging period”, no messages carrying a given source address have been received on the interface it is associated with, such association is removed (“forgotten”). In the event of a network topology change, it is common in standards such as IEEE Std 802.1D (Spanning Tree Protocol) or IEEE Std 802.1W (Rapid Spanning Tree Protocol) to either immediately erase all associations or reduce the aging period significantly for existing associations maintained by a switch identifying a topology change (either directly or indirectly).

In an exemplary embodiment of the present invention, in the event of a topology change prior to the expiration of the LBP the address aging or immediate erasure processes can be eliminated or postponed for a period of time after the topology change. In the example associated with FIG. 1, if during the LBP for the address of N100 a topology change were to occur immediately following the arrival of the frame form N100 to S100 (e.g. L700 connecting S200 to S400 is revived from its previously disconnected state) and looping traffic is still present, it is undesirable to age out the association of N100 until the end of the LBP.

It is foreseen that in the event of topology changes learning may possibly be performed based on looping frames rather than the first time arrival of a frame from the source (e.g. this could happen if the first arrival on a new ingress interface occurs during the LBP that begun prior to a topology change). However, if such learning is erroneous (i.e. it causes an address to be associated to a port that does not lead to the shortest path to the node) such error will be corrected immediately following the reception of a new (non-looping) frame from that same source. This means that following a topology change a short period of communications discontinuity may occur, however such effect is both rare as well as expected in such events even with standard protocols such as IEEE Std 802.1D/W.

If during the LBP for a given source address associated with a given interface a frame arrives with the same source address on another interface, it may be assumed that such a frame is a looping frame or a copy of a frame that will arrive or has already arrived on the interface associated with the source address. Hence, in one embodiment such a frame may be dropped instead of being forwarded. An embodiment of the present invention in addition to dropping the looping frame additional steps can be added to eliminate looping traffic altogether. Those steps are disclosed below.

### Method for the Suppression of Looping Traffic

As mentioned above, in order to allow correct functionality of switches in redundant networks with a multiplicity of paths between certain (or all) pairs of nodes, a mechanism can be added for rapid elimination of looping traffic. More formally, a mechanism can be added for dropping frames in the event they arrive more than a (small) given number of times at the same network node. Such mechanisms are known in the art as “loop suppression” mechanisms. An algorithm for implementing such a mechanism will be defined as a “Loop Suppression Algorithm” (LSA). An exemplary novel mechanism of LSA that can be added to some embodiments of the present invention is disclosed below.

A “simple loop” in the network is a path that a frame may travel across that originates and ends at a given node in the network and crosses each node on the way exactly one time. The time required for a frame to travel over the longest possible simple loop in the network is defined herein as the “Maximum Loop Travel Time” (MLTT). The MLTT for a typical local area network will be in the order of (a few) milliseconds at the most.

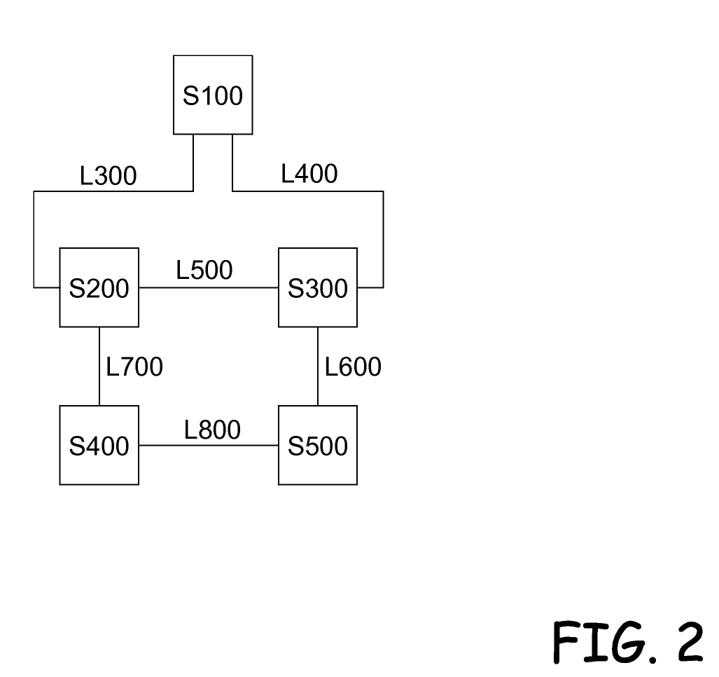

FIG. 2 depicts an exemplary network with multiple loops in it. This network has three simple loops in it: S100-S200-S300, S200-S300-S500-S400 and S100-S300-S500-S400-S200. If it takes one time unit to travel each hop (link) in the network, the travel times for the three loops would be three units, four units and five time units respectively and the MLTT would be five time units.

The number of times a frame is allowed to travel around a (simple) loop is defined herein as the “Maximum Lap Count” (MLC). The MLC would ideally be one, but may be higher for certain types of traffic.

A time period which is the maximum time that can pass between the first arrival of a given frame at a node in the network and the last possible time it may arrive again at that node is defined herein as the “Maximum Loop Duration” (MLD). In a network where the MLC is enforced to be finite, the MLD is no longer than MLC multiplied by MLTT.

In one embodiment, given the MLD as defined above, the LBP may be set to at least the MLD. This ensures that for the LSA described hereafter, following the arrival of a frame that triggers the association of its source address to a given port, no copies of this frame will be accepted for learning at the switch during the LBP.

In essence, an LSA must recognize a frame as one that has previously been received and drop it. A method is hence required to efficiently record and store information on frames that have been received in the past. In one embodiment of an LSA, such record may be limited to frames received in a timeframe equivalent to (or slightly higher than) the MLD. Such an LSA will be termed a “Limited Past LSA” (LPLSA).

One embodiment of an LPLSA described herein uses one or more tests in order to deduce if a frame has been received within the past MLD. If it is determined with the required level of certainty that an identical frame has indeed been received within this timeframe, the frame is discarded.

Each test may be defined by the following parameters:
a. Which parts of the frame to perform the test on, the “Test Subject”: This may be the entire frame or a given part of it such as certain headers, a prefix of the frame (e.g. the Ethernet MAC addressed or IP addresses), a certain field within the frame (e.g. the TCP checksum) or a trailer of the frame (e.g. the Ethernet FCS field).
b. A calculation to be performed on the test subject, the “Test Calculation”: This may be a Cyclic Redundancy Check (CRC) of a given length, a logical operation such as a XOR function on the bytes of the test subject, extraction of a given part of the data within the test subject or any other algorithmic methods. The result of the Test Calculation is called herein the “Frame Fingerprint”.
c. A threshold number, the “Test Threshold”: This may be a (small) integer below or equal to the MLC.
d. The “Test Significance”: This is a unique rank attributed to the test. No two tests are assigned the same Test Significance.

The set of tests performed by the LPLSA may be ordered according to their Test Significance from the least significant test to the most significant test. This order of significance is defined by the designer of the LPLSA. It typically reflects the probability of two frames being identical if a test of given significance and all tests of lower significance are considered successful (see below); the higher this probability, the higher the test significance.

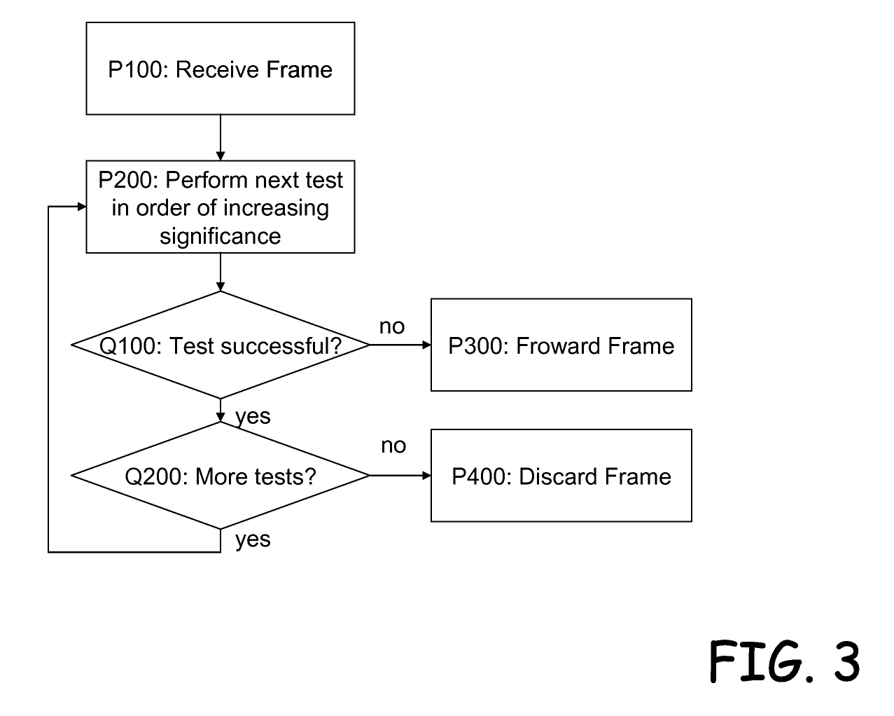

FIG. 3 depicts relevant processes of an exemplary embodiment of a LPLSA procedure, where the tests are performed in order of their Test Significance. The process is initiated (P100) for each received frame. The test of least Test Significance is performed for every frame (P200). If (Q100) the test fails, the frame is forwarded (P300). If (Q100) the test is successful (the frame is suspected to be identical to a previous frame). A decision is made (Q200) whether other tests remain to be performed. If (Q200) no additional test exist, this means that all tests of lower significance are successful for a given frame, and the frame can be assumed to be looping and therefore discarded (P400). If all tests are successful, it is assumed that the frame processed has been previously received within the past MLD and the frame is discarded (P400). If (Q200) an additional test exists, the process return to step P200 executing the next test. In another embodiment of the LPLSA, tests can be performed in no particular order and frames can be discarded based on a subset of tests succeeding (e.g. based on a majority of tests succeeding).

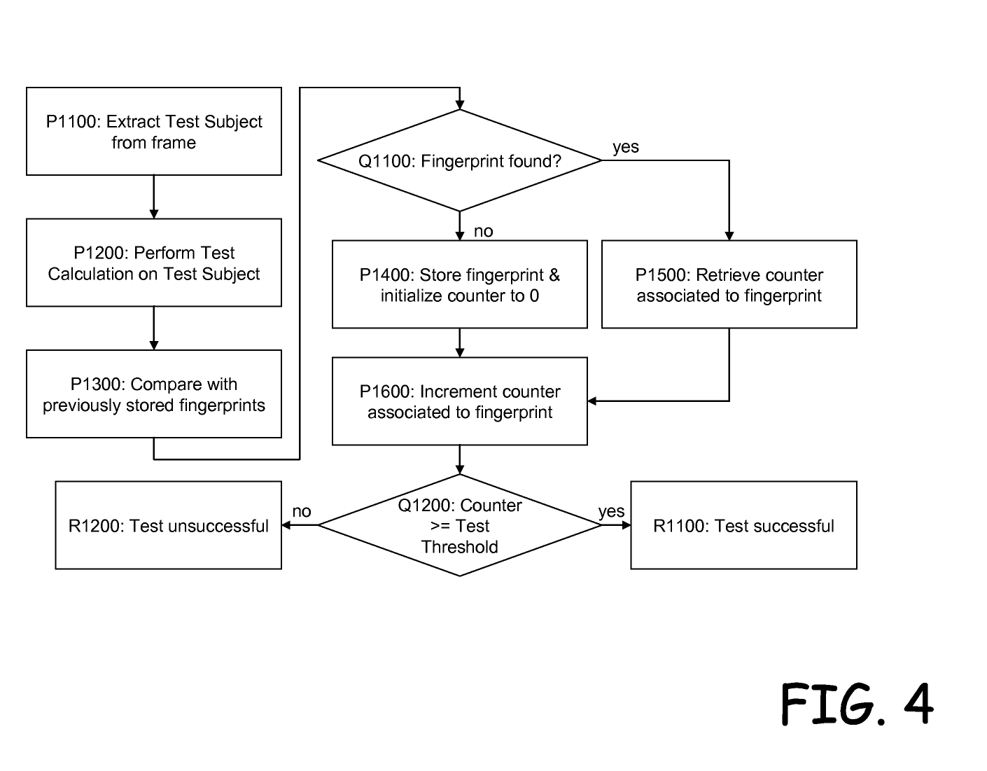

FIG. 4 depicts relevant steps performed by an exemplary test procedure. At the beginning of the test the Test Subject is extracted from a frame (P1100). Then the Test Calculation is executed on the Test Subject (P1200) and the resulting Frame Fingerprint is compared with previously stored Frame Fingerprints (P1300). If the Frame Fingerprint does not match a Frame Fingerprint previously stored (Q1100) then the fingerprint is stored and associated with a counter that is initialized to zero (P1400). If the Frame Fingerprint is identical to a previously stored Frame Fingerprint (Q1100), a counter associated with the Frame Fingerprint is retrieved (P1500). In both cases, the counter is incremented (P1600). At step Q1200 a decision is made whether the counter reaches or exceeds the Test Threshold. If so, the test is considered successful (R1100). Otherwise, the test is considered unsuccessful (R1200).

In one embodiment of the LPLSA, in addition to the above steps, it is recorded at what time a Frame Fingerprint is seen. If a fingerprint stored is not seen for longer than the MLTT it is deleted from storage

In an embodiment of the LPLSA, in addition to the above steps, the fingerprint storage for each test may be limited to fixed size storage. In the event that a fingerprint must be stored and fingerprint storage quota for a given test is depleted, the test is considered unsuccessful (and the frame is forwarded).

In another embodiment of the LPLSA, time can be segmented into indexed time slots. During the first time slot, only the least significant test is performed. In the following time slot the two least significant tests are performed. In a similar manner, during every following time slot, one more test is added to the list of tests that are performed until all tests are performed during every time slot. A test can be performed on a frame only if the frame would have been successful for the previous test in the order of significance in the previous timeslot (i.e. the counter for its fingerprint in the previous test during the previous time slot reached or exceeded the Test Threshold). Following every time slot, all recorded information for some or all of the tests may be deleted (i.e. fingerprint counters are reset to zero).

In some embodiments the length of the timeslot may vary per test or may be fixed for all tests. For instance, assume a test T1 is performed over multiple MLTT periods, and a following test T2 is performed over a single MLTT period. T2 may be executed on frames for which T1 was successful over the last MLTT period it is run for. A similar effect would be achieved had T1 been subdivided into multiple tests, each for a single MLTT period.

### Effective Tests for LPLSA

In order to create an effective and efficient LPLSA, tests can be defined to identify and drop looping frames within the required MLD. This can be performed in such a way that looping frames recurring at the most every MLTT are distinguishable from valid frame retransmissions by hosts (and other normal traffic) while keeping storage requirements to minimum.

In order to meet MLD requirements, in one embodiment of the LPLSA, the sum of Test Thresholds must not exceed MLC.

In order to be able to distinguish between looping frames and valid frame retransmissions, MLTT is assumed to be lower than the minimal average interval between recurring frames transmitted by hosts. In general, it can be safely assumed that this is the case as long as MLTT is in the order of milliseconds.

One embodiment of a test is based on the fact that for looping frames the frequency of frame recurrence is at least 1/MLTT. A test may be designed to produce enough different Frame Fingerprints at almost even distribution for non-identical frames such that looping frames will stand out by the rate of appearance of their Frame Fingerprints, which will be significantly higher than the fingerprint rate of appearances for non-looping frames. By identifying such Frame Fingerprints that appear within a given timeframe at a significantly higher rate than normal evenly distributed Frame Fingerprints, a subset of traffic may be identified that includes potentially looping frames.

For one embodiment of a test, the aggregate rate of frames being screened is R. The test may be beneficial if it can evenly distribute non-identical frames across more than R*MLTT (e.g. 2*R*MLTT) different Frame Fingerprints. A fingerprint appearing at a rate of 1/MLTT or higher has the potential of belonging to looping traffic. However, assuming that fingerprints can be generated with almost even distribution, fingerprints for non-looping frames which will be non-identical will appear at an average rate of 1/(2*MLTT)—half the rate of looping frames. Hence, fingerprints appearing at a rate of 1/MLTT will tend to be relatively scarce. This may be measured by a test with a Test Threshold of T, by identifying the Frame Fingerprints that appear at least T times over a period of T*MLTT. In one embodiment of such a test, T may be chosen to be two.

The following test may be built in an identical format, with respect to a rate R2 that is a fractional rate of R. This fraction may be derived as the expected number of fingerprints over a period of T*MLTT that exceed the threshold T for the previous test divided by number of potential fingerprints for that test (e.g. 2*R*MLTT). This fraction may de derived using combinatoric methods known in the art and related to the problem known as the Occupancy Problem (see below).

Fingerprints that do not recur at least every MLTT do not belong to looping traffic (which has a frame appearing at least every MLTT) and may hence be deleted. Note that over a period of MLTT, only R*MLTT frames will be observed. Hence, in an embodiment of such a test, storage for the test may be limited to R*MLTT memory entries for storing fingerprints with their associated counters and time stamps.

By tuning the parameters of a test it may be used to reduce the number of Frame Fingerprints appearing at a rate of 1/MLTT or more and hence the potential number of frames that require further screening for loops. For such frames, additional tests may be defined to perform further similar reductions. Finally, the most significant test can be designed to store a Frame Fingerprint for every remaining frame to be screened that is significant enough to reduce the probability of erroneous detection of a non-looping frame as such to negligible values (e.g. by storing a strong 48-bit CRC of the entire frame or by storing the entire frame altogether). Due to the limited number of frames that require such storage, overall storage requirements are significantly lower than required by algorithms using a single test based on the most significant fingerprint only.

In one embodiment of the LPLSA, one or more of the least significant test may be performed per interface. Hence, they may be distributed within a switching device such that no central calculation is required for them. Only the most significant test may need to be performed for all incoming traffic (on all interfaces). The rate of frames that require the execution of the most significant test may be reduced to a rate that corresponds to the maximal expected rate of looping frames in the network. Hence, this approach can be scaled to very large systems.

An exemplary implementation of an LPLSA for handling an aggregate frame arrival rate R of 4,000,000 frames per second in a network where the MLTT is five milliseconds can use three tests in order of significance as follows for detecting looping frames:
a. Test1: Test Subject as the entire frame, Test Calculation as the 16 most significant bits of a 32-bit CRC, exemplary Test Threshold can be set as two and Test Significance can be set as one (the least significant test).
b. Test2: Test Subject as the entire frame, Test Calculation as the 14 least significant bits of the same 32-bit CRC as in Test1, Test Threshold set as four and Test Significance set as two.
c. Test3: Test Subject as the entire frame, Test Calculation as a 48-bit CRC, Test Threshold set as two and Test Significance set as three (most significant).

Test1 associates traffic with 64K different Fingerprints. During a period of ten milliseconds (2*MLTT) 40,000 frames will arrive. If all are non-identical, each one of them will be associated with one of the 64K possible fingerprints. A combinatorial calculation based on the well known Occupancy Problem shows that on average about 8213 fingerprints will appear two times or more for non-looping traffic (assuming uniform distribution of fingerprints) over this period. Hence, as traffic continues to flow, it is sufficient to focus on about 8213 Test1 fingerprints out of a potential of 64K. Hence, Test2 can suffice with 16K different potential fingerprints reserved only for frames with recurring fingerprints within Test1. This test is performed for an average of 8213/64K*4,000,000 or about 500,000 frames per second. At this rate, during the next four MLTT periods, only about 10000 frames are expected to arrive. Again, based on the classic Occupancy Problem combinatorics, it can be calculated that on average less than 59 fingerprints are likely to appear four times or more over the period of four MLTTs. Hence, the final and most significant Test3 needs to deal with about 59/16K*500,000 or about 1800 frames per second. At such a rate, only slightly more than 18 frames are expected to arrive over the following two MLTT periods. Hence, clearly, in terms of storage as well as in terms of processing, almost any test for identifying two consecutive identical frames including full frame storage and comparison can be executed. Calculating a 48-bit CRC checksum can be used, for example, (the length of the checksum is intended to reduce the probability of false detection to a minimum below any significance).

In the above example, if looping traffic exists, it will immediately pass all tests and hence identification of the loop can be performed immediately upon the arrival of the 8^{th} copy of an identical frame (two for Test1, four for Test2 and two for Test3).

In order to increase the throughput and exemplary embodiments may work on two or more interfaces in parallel. Test1 and Test2 may be performed per interface (each with separate resources and handling 4,000,000 frames per second each). Test3, which needs to handle only very few frames in the absence of looping traffic may be implemented as a central test for all interfaces. In the presence of looping traffic, Test3 will be stressed at a frame rate corresponding to the maximal rate of looping frames.

### Using Multiple Versions of LPLSA Simultaneously

Under some circumstances it may be beneficial to implement multiple versions of the LPLSA, to allow different types of treatment for different types of traffic.

In one embodiment, one instance of LPLSA is used for suppression of looping broadcast and multicast frames while one or more other instances of LPLSA are used for the suppression of unicast frames. In such an embodiment, suppression of broadcast and multicast frames may be performed by an LPLSA with a single (most significant) test dropping frames immediately upon their second arrival. At the same time, the LPLSA for unicast traffic may allow multiple copies of identical looping frames to be forwarded before they are eventually dropped. Such a mechanism is useful in networks where broadcast and multicast frames are a minority of the frames. Since multiplication of such frames, can cause significant damage to the network, their immediate suppression is important. On the other hand, implementing an LPLSA that immediately drops second appearances of all types of frames may be prohibitively costly in terms of the storage required.

In another embodiment, one LPLSA is used for suppression of specific unicast frames while one or more LPLSA's are used for suppression of other frames. In one such embodiment, the specific unicast frames are frames with unknown destination addresses that are to be flooded to all interfaces.

### System and Method for Protecting Standard Ethernet Switches

An exemplary embodiment of the present invention can add logical modules to Ethernet switching devices. Wherein the logical modules can implement one or more of the exemplary methods for correcting address learning in the presence of multiple paths (CALPMP) that are described above. The new Ethernet switching device can have the capabilities similar to those of existing switches described in the art, with the benefit of being able to perform correct frame forwarding even in the presence of loops in a redundant network and without the need to implement a communications protocol for disabling links in the network such as a Spanning Tree Protocol.

In one embodiment, such a system may be comprised of a standard Ethernet switching element with its interfaces connected to other network devices through a loop enabling element implementing one or more LPLSA methods that are described above. The learning algorithm of the switch itself, also known in the art as the filtering mechanism, can be replaced by a mechanism with one or more CALPMP methods that are disclosed above.

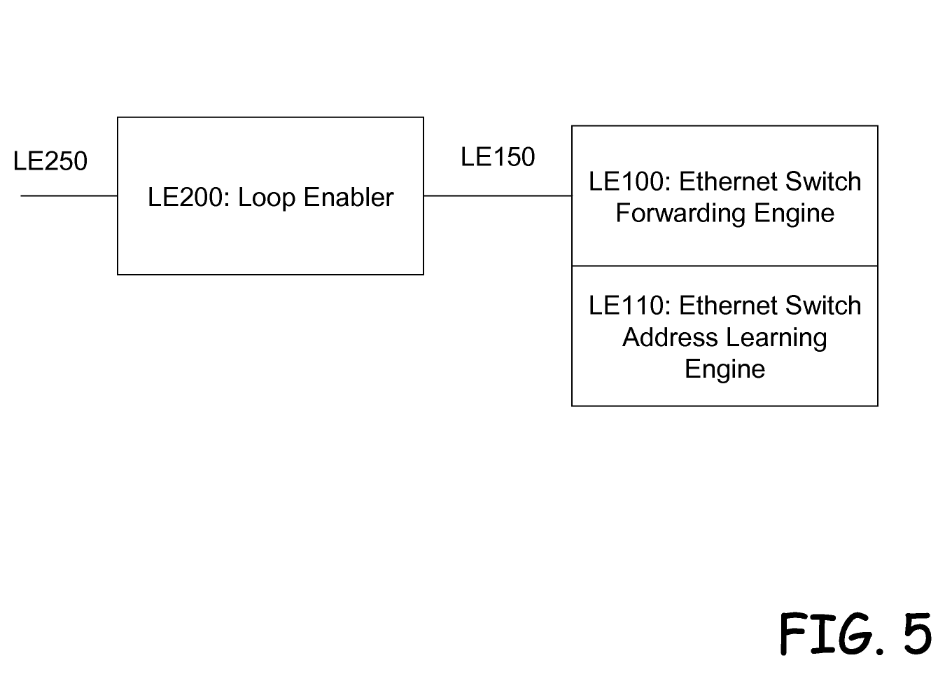

FIG. 5 depicts one embodiment of a system that performs correct Ethernet switching in the presence of loops and without disabling links in a redundant network. The system can comprise a standard Ethernet Switch as known in the art (LE100+LE110) and a Loop Enabler element (LE200). The switch is subdivided into a Forwarding Engine (LE100) and an Address Learning Engine (LE110). Wherein the forwarding engine (LE100) is responsible for forwarding Ethernet frames and Address Learning Engine (LE110) is responsible for learning Ethernet MAC addresses and their association with the switch interfaces using one or more CALPMP methods that were described above.

In another embodiment, such a system may be comprised of a standard Ethernet switching device as described in the art implemented as a stand-alone device that is connected to a loop enabling device through external interfaces. Such a loop enabling device can implement one or more LPLSA methods as well as the LBP alteration, which are disclosed above, by dropping frames with a source address that has been identified on frames on another interface within the LBP. In addition, in the event of topology changes, the loop enabling device may transmit Topology Change Notification (known in the art as TCN messages) to the Ethernet switch device in order to cause it to age out its MAC tables known in the art as filtering databases.

In the event that multiple ports on a switch are grouped together as a single interface, for instance based on the IEEE Std 802.3ad link aggregation standard, all such ports should be treated as a single interface by exemplary LBP alteration.

The above loop enabling device may be used in another embodiment, as a stand-alone device for suppressing looping traffic in networks with redundant links without implementing the LBP alteration. Such device may be used to drop looping traffic or alternatively to indicate its existence.

In another embodiment, such loop enabling devices may be used in Internet Protocol (IP) or Multiple Protocol Label Switching (MPLS) networks to suppress looping traffic typically resulting from transient routing protocol behavior. Such loops are known in the art as micro-loops.

### Clarifications

It should be noted that the terms “frame”, “data frame”, “Ethernet frame”, “packet”, “data packet” and “IP packet” can be used interchangeably herein.

It should be noted that the terms “switch”, “bridge”, “Ethernet switch”, “Ethernet bridge”, “Ethernet switching node”, “Ethernet switching device”, “switching node” and “switching device” can be used interchangeably herein.

A logical module can be any one of, or any combination of, software, hardware, and/or firmware. It will be appreciated that the above described modules may be varied in many ways, including, changing the number modules, and combining two or more modules into one. Dividing the operation of a certain module into two or more separate modules, etc.

In the description and claims of the present disclosure, “comprise,” “include,” “have,” and conjugates thereof are used to indicate that the object or objects of the verb are not necessarily a complete listing of members, components, elements, or parts of the subject or subjects of the verb.

### Prior Art about the Difficulties in Implementing Loop Suppression

### References to Loop Suppression

Interestingly, in the IETF draft known as draft-bryant-shand-lf-conv-frmwk-03.txt, dated October 2006, it is explicitly mentioned that loop suppression is probably infeasible. Here is the exact quote: “A micro-loop suppression mechanism recognizes that a packet is looping and drops it. One such approach would be for a router to recognize, by some means, that it had seen the same packet before. It is difficult to see how sufficiently reliable discrimination could be achieved without some form of per-router signature such as route recording. A packet recognizing approach therefore seems infeasible.”

Clearly, at least to the authors of the above, the method described and claimed herein is both novel and non-trivial.

### Relevant Combinatorics (the Occupancy Problem)

A few classic tools related to the problem known in the art as the Occupancy Problem are helpful in determining parameters of the LPLSA. The Occupancy Problem is described as: Given N bins and K balls thrown into them, how many bins will be left empty on average? Here are a few related combinatoric formulas:

P(N)=N!−the number of permutations of N elements. a.

C(K,N)=P(K)/[P(K−N)P(N)]−the number of combinations of choosing N elements out of K possible elements. b.

P0=1/N−probability of a ball hitting a bin. c.

P(M,K,N)=C(K,M)*P0̂M*(1−P0)̂(K−M)−probability that one given bin receives exactly M balls out of K thrown into N bins. d.

E(M,K,N)=N*P(M,K,N)−expected number of bins with exactly M balls after K balls have been thrown into N bins. e.

S(R,K,N)=sum(0<=M<=R, E(M,K,N))−the expected number of bins with up to R balls. f.

S(R,K,N) as defined above can be useful for determining the number of possible Test Fingerprints and Test Threshold of the LPLSA tests. In this case, the bins can be the number of possible fingerprints and the balls can be the number of frames handled during a given period such as MLTT.

It will be appreciated that the above described methods may be varied in many ways, including, changing the order of steps, and the exact implementation used. It should also be appreciated that the above described description of methods and apparatus are to be interpreted as including apparatus for carrying out the methods and methods of using the apparatus.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1. A method for learning the topology of a redundant network having a plurality of intermittent network nodes, wherein each network node has a plurality of ingress interfaces, each ingress interface is associated with another network node, the method comprising:
receiving, at a first network node, a first frame coming from a second network node;
analyzing the received first frame;
defining the address of a first terminal, which creates the frame, by retrieving a source address of the received first frame;
determining if another frame having the source address of the first frame has been received during a first time interval before receiving the first frame, ignoring the analysis results of the first received frame if another frame has been received during the first time interval; and if no other frame was received, associating the second network node as the next hop for a future received frame targeted toward the first terminal.

2. The method of claim 1, wherein the learning of the next hop for frames targeted toward the first terminal is executed for the earliest received frames having source address of the first terminal and the frames were received via the second network node.

3. The method of claim 1 where the first time interval is substantially equal to the time it takes network nodes to discard a frame that is traveling around a loop in the network.

4. The method of claim 1 where the first time interval is substantially equal to the time it takes for traveling in a loop in the network.

5. A method for detecting recurring patterns within a given set of patterns, the method comprising:
defining an ordered sequence of tests with increasing significance, wherein the significance reflects the probability of two patterns being identical if a test of given significance and all tests of lower significance are considered successful;
executing the sequence of tests on a pattern;
identifying the pattern as recurring if the most significant test is successful.

6. The method of claim 5, wherein a test with the lowest significance is executed first on a pattern.

7. The method of claim 6, wherein a next significant test is executed if a previously significant test was successful.

8. The method of claim 5, wherein each test is defined by a Test Subject, a Test Calculation, a Test Memory and a Test Threshold.

9. The method of claim 8, wherein the Test Subject is part of or the entire pattern.

10. The method of claim 8, wherein the Test Calculation is calculations performed on the Test Subject resulting in a Test Fingerprint.

11. The method of claim 8, wherein the Test Memory is the time or number of recent patterns to be considered and the Test Threshold is an integer defining the number of identical Test Fingerprints to be identified within the Test Memory for determining whether the test is considered successful.

12. The method of claim 5, wherein the patterns are data frames arriving at a given network node in a data network.

13. The method of claim 12, wherein the method is used for identifying looping traffic in the data network.

14. The method of claim 12, wherein the Test Calculation is a Cyclic Redundancy Check.

15. The method of claim 12, wherein the Test Calculation is the extraction of a field or a set of fields from the data frame.

16. The method of claim 15, wherein the extraction is an embedded checksum or an address.

17. The method of claim 12, wherein the data network is an Ethernet network.

18. The method of claim 8, wherein a test calculation of the next significant test is a function of the ‘Maximum Loop Travel Time’ of the network and the rate of inspected looping packets that were found in the previously significant test.

19. The method of claim 12, where the data frames are Ethernet frames.

20. The method of claim 12, where the data frames are Internet Protocol (IP) packets.

21. The method of claim 12, wherein the test depends on the data frame's type.

22. The method of claim 21, wherein frame's type can be selected from a group consisting of: unicast, multicast and broadcast.

23. The method of claim 12, wherein the data network is a Multiple Protocol Label Switching (MPLS) network.

24. A system for employing the method from claim 0, wherein the system forwards (switches) data frames in a data network.

25. The system of claim 24, wherein the data network is an Ethernet network.

26. A system for employing the methods of claim 1 and claim 5, wherein the system forwards (switches) data frames in a network with redundant links which are enabled.

27. The system of claim 26, wherein the data network is an Ethernet network.

28. A system for employing the method from claim 5, wherein the system identifies data frames traveling in a loop in a data network.

29. The system of claim 28, wherein the data network is an Ethernet network.

30. The system of claim 28, wherein the data network is an IP network.
